(19) United States
(12) Patent Application Publication
(10) Pub. No.: US 2001/0024694 A1
(43) Pub. Date: Sep. 27, 2001

(54) Method of forming metallic coating films

(76) Inventors: Hiroto Yoneda, Osaka (JP); Daisuke Segawa, Yokohama-shi (JP); Shoki Tsuji, Osaka (JP); Akira Fushimi, Ikoma-shi (JP)

Correspondence Address: Shanks & Herbert, TransPotomac Plaza, 1033 N. Fairfax Street, Suite 306, Alexandria, VA, 22314, US

(21) Appl. No.: 09/769,755

(22) Filed: Jan. 26, 2001

(30) Foreign Application Priority Data
Jan. 26, 2000 (JP) 2000-017261

(51) Int. Cl. B05D 1/36

(52) U.S. Cl. 427/405; 427/407.1

(57) ABSTRACT

The present invention, therefore, provides a method of forming a metallic coating film comprising forming a metallic base coating film and a clear top coating film on a substrate provided with an undercoating film and optionally an intermediate coating film in advance,

wherein the metallic base coating for forming said metallic base coating film contains a non-crosslinked polymer particle having a mean particle diameter (D₅₀) of 0.05 to 10 μm and a crosslinked polymer particle having a mean particle diameter (D₅₀) of 0.01 to 1 μm in a ratio of the former/latter =5/1 to 1/5 on a solid weight basis.

### FIELD OF THE INVENTION

The present invention relates to a method of forming a metallic coating film on an automotive body and other substrates and to a metallic coating film obtained by the method.

### BACKGROUND OF THE INVENTION

Recent years have seen demands for the metallic coating films formed by using the so-called metallic coatings containing luster color pigments as a top coating film. The metallic coating film is formed by applying a metallic base coating and a clear coating on a wet-on-wet technique but if the metallic base coating film and clear coating film are intermingled, the orientation of the luster color pigment particles in the metallic base coating film is disturbed to sacrifice the flip-flop effect and reduce the gloss of the coating film.

Generally for viscosity control in coating and curing, it is a known practice to add a crosslinked polymer microparticle as a viscosity modifier to metallic base coatings but the practice is not always fully rewarding.

### SUMMARY OF THE INVENTION

The object of the present invention is to provide a metallic coating film having good flip-flop properties as implemented through improvements in the orientation of the luster color pigment in a metallic base coating film with good reproducibility and prevention of the so-called inversion of color due to delicate intermingling of the metallic base coating film and clear coating film.

The present invention, therefore, provides a method of forming a metallic coating film comprising forming a metallic base coating film and a clear top coating film on a substrate provided with an undercoating film and optionally an intermediate coating film in advance,

wherein the metallic base coating for forming said metallic base coating film contains a non-crosslinked polymer particle having a mean particle diameter (D₅₀) of 0.05 to 10 μm and a crosslinked polymer particle having a mean particle diameter (D₅₀) of 0.01 to 1 μm in a ratio of the former/latter =5/1 to 1/5 on a solid weight basis.

The present invention further provides a metallic base coating for use in the above method and a metallic coating film obtainable by said method.

The present invention is now described in detail.

### DETAILED DESCRIPTION OF THE INVENTION

Metallic base coating film

In the method of forming a metallic coating film according to the present invention, the metallic base coating film thereof is formed using a metallic base coating. This metallic base coating comprises a non-crosslinked polymer particle, a crosslinked polymer particle, a luster color pigment, an organic or inorganic colored pigment, a film-forming resin and a curing agent.

The particulate non-crosslinked resin to be formulated in the metallic base coating of the present invention can be prepared by copolymerizing a polymeric monomer in a mixture of a dispersion-stabilizing resin and an organic solvent to thereby form non-crosslinked resin particles insoluble in said mixture. The monomer to be thus copolymerized in the presence of said dispersion-stabilizing resin for the preparation of said particulate non-crosslinked resin (polymer) is not particularly restricted as far as it is selected from among radical-polymerizable unsaturated monomers.

However, in order to synthesize said dispersion-stabilizing resin and said non-crosslinked polymer particle, a polymeric monomer having a functional group is preferably used, for such a non-crosslinked polymer particle having a functional group and a dispersion-stabilizing resin carrying functional groups react with the curing agent described hereinbelow to form a three-dimensional cured film.

The dispersion-stabilizing resin mentioned above is not particularly restricted as far as it is conducive to the formation of a non-crosslinked polymer particle in an organic solvent with good reproducibility. Specifically, an acrylic, polyester, polyether, polycarbonate, polyurethane or the like resin which has a hydroxyl value of 10 to 250, preferably 20 to 180, an acid value of 0 to 100 mg KOH/g, preferably 0 to 50 mg KOH/g, and a number average molecular weight of 800 to 100000, preferably 1000 to 20000, is preferably used. When the upper limit value for any of the above parameters is exceeded, the ease of handling of the resin is adversely affected and that of the non-crosslinked polymer particle is also sacrificed. When any of said parameter values is below the lower limit, the resin tends to separate out in the coating film or the stability of the particles is adversely affected.

The technology of synthesizing the above dispersion-stabilizing resin is not particularly restricted but may preferably be the method comprising a radical polymerization in the presence of a radical polymerization initiator or the method comprising a condensation reaction or an addition reaction. The monomer for use in the preparation of the above dispersion-stabilizing resin can be judiciously selected according to the necessary resin characteristics but a monomer having a functional group, such as a hydroxyl group and an acidic group, like the polymeric monomer for use in synthesizing the non-crosslinked polymer particle as described hereinafter is preferably employed. If necessary, a monomer having a glycidyl group, an isocyanate group or the like functional group may also be employed.

The relative amounts of said dispersion-stabilizing resin and said polymeric monomer can be freely selected according to the intended use. Thus, for example, the dispersion-stabilizing resin preferably accounts for 3 to 80 weight %, particularly 5 to 60 weight %, and the polymeric monomer preferably accounts for 97 to 20 weight %, particularly 95 to 40 weight %, both based on the total weight of the two components. Furthermore, the combined concentration of the dispersion-stabilizing resin and polymeric monomer in the organic solvent is preferably 30 to 80 weight %, particularly 40 to 60 weight %, based on the total weight.

The non-crosslinked polymer particle mentioned above can be prepared by polymerizing a radical-polymeric monomer in the presence of the dispersion-stabilizing resin. Preferred non-crosslinked polymer particle has a hydroxyl value of 50 to 400, particularly 100 to 300, an acid value of 0 to 200 mg KOH/g, particularly 0 to 50 mg KOH/g, and a mean particle diameter (D₅₀) of 0.05 to 10 μm, particularly 0.1 to 2 μm. When any of these parameter values is below the lower limit, the sustained particulate form may not be obtained, while when it exceeds the upper limit, the stability of the particles dispersed in the coating is decreased.

The polymeric monomer having a functional group for use in synthesizing said non-crosslinked polymer particle includes the following, to mention just a few representative examples. Thus, as the monomer having a hydroxyl group, there can be mentioned hydroxyethyl (meth)acrylate, hydroxypropyl (meth)acrylate, hydroxybutyl (meth)acrylate, hydroxymethyl (meth)acrylate, allyl alcohol, and hydroxyethyl (meth) acrylate-ε-caprolactone adduct, among others.

As the polymeric monomer having an acidic group, there can be mentioned monomers having a carboxyl group, a sulfo group or the like. As examples of the monomer having a carboxyl group, there can be mentioned (meth)acrylic acid, crotonic acid, 3-butenoic acid, 4-pentenoic acid, 2-methyl-3-butenoic acid, itaconic acid, maleic anhydride, fumaric acid, and the like. As examples of the polymeric monomer having a sulfo group, there can be mentioned t-butylacrylamidosulfonic acid, and the like. When polymeric monomers having an acidic group are used, it is preferred that some of the acidic groups be carboxyl groups.

Furthermore, as examples of said polymeric monomer, there can be mentioned glycidyl-containing unsaturated monomers such as glycidyl (meth)acrylate and isocyanato-containing unsaturated monomers such as m-isopropenyl-α, α-dimethylbenzyl isocyanate, isocyanatoethyl acrylate, etc.

As further examples of the polymeric monomer, there can be mentioned (meth)acrylic acid alkyl esters such as methyl (meth)acrylate, ethyl (meth)acrylate, isopropyl (meth)acrylate, n-propyl (meth)acrylate, n-butyl (meth)acrylate, t-butyl (meth)acrylate, isobutyl (meth)acrylate, 2-ethylhexyl (meth)acrylate, n-octyl (meth)acrylate, lauryl (meth)acrylate, stearyl (meth)acrylate, tridecyl (meth)acrylate, etc.; adducts of oil-derived fatty acids with acrylic or methacrylic ester monomers having an oxirane structure (e.g. stearic acid-glycidyl methacrylate adduct), adducts of oxirane compounds containing C₃ or higher alkyl groups with acrylic acid or methacrylic acid, styrene, α-methylstyrene, o-methylstyrene, m-methylstyrene, p-methylstyrene, p-t-butylstyrene, benzyl (meth)acrylate, itaconic esters (e.g. dimethyl itaconate), maleic esters (e.g. dimethyl maleate), fumaric esters (e.g. dimethyl fumarate), acrylonitrile, methacrylonitrile, methyl isopropenyl ketone, vinyl acetate, Veova monomers (trade mark, Shell Chemical), vinyl propionate, vinyl pivalate, ethylene, propylene, butadiene, N,N-dimethylaminoethyl acrylate, N,N-dimethylaminoethyl methacrylate, acrylamide, vinylpyridine and other polymeric monomers.

The polymerization reaction for preparing said non-crosslinked polymer particle is preferably carried out in the presence of a radical polymerization initiator. As the radical polymerization initiator, there can be mentioned azo initiators such as 2,2′-azobisisobutylonitrile, 2,2′-azobis(2,4-dimethylvaleronitrile), etc., benzoyl peroxide, lauryl peroxide, t-butyl peroctoate, and so on. Preferred amount of use of the initiator is 0.2 to 10 weight parts, more preferably 0.5 to 5 weight parts, based on 100 weight parts of the total polymeric monomer. The polymerization reaction in an organic solvent containing the dispersion-stabilizing resin for preparing the non-crosslinked polymer particle is preferably carried out generally within a temperature range of about 60 to 160° C. for about 1 to 15 hours.

Unlike the crosslinked polymer particle, the above non-crosslinked polymer particle is characterized in that while it is particulate in a coating, it does not assume a particulate structure in a coating film. In other words, the non-crosslinked polymer particle is different from the crosslinked polymer particle in that because the former particle has no crosslinked part internally, it may undergo morphological change in the process of curing to constitute a part of the resin.

However, the non-crosslinked polymer particle does not cause an expression of structural viscosity when added alone to a coating system. However, a marked structural viscosity develops when it is used in combination with the crosslinked polymer particle.

In addition, the particulate resin called NAD (non-aqueous dispersion) for the NAD coatings described in Color Material, 48, 28-34 (1975) can also be used.

On the other hand, said crosslinked polymer particle is insoluble in the organic solvent and has a mean particle diameter (D₅₀) of 0.01 to 1 μm. When the mean particle diameter is greater than the upper limit, the stability is decreased and when it is below the lower limit, a considerable demands are required for production equipment parameters and the particle morphology also can hardly be controlled. The crosslinked polymer particle mentioned above is preferably prepared by emulsion polymerization of a polymeric monomer in the presence of a polymerization initiator and, as a polyol component, a resin having an emulsifility, such as an alkyd resin and polyester resin synthesized by using a monomer containing a zwitterion group in aqueous medium.

The zwitterion group mentioned above is expressed by the formula —N⁺—R—COO⁻ or —N⁺—R—SO₃⁻ (wherein R represents a straight-chain or branched alkylene group containing 1 to 6 carbon atoms), and as the monomer having such a group within the molecule, a compound having 2 or more hydroxyl groups can be used. Thus, among the monomers which can be used, hydroxy-containing aminosulfonic acid type amphoteric compounds are preferred from synthetic points of view. As a specific example, there can be mentioned bishydroxyethyltaurine, and the like.

The above-mentioned resin containing a zwitterion group and having an emulsifility as synthesized by using the above monomer is preferably a polyester resin having an acid value of 30 to 150 mg KOH/g, preferably 40 to 150 mg KOH/g, and a number average molecular weight of 500 to 5000, preferably 700 to 3000. When the above upper limits are exceeded, the ease of handling of the resin is adversely affected. When those parameter values are below the lower limits, the emulsifying resin may separate out on coating film or the solvent resistance of the films is decreased.

As the polymeric monomer to be emulsion-polymerized in synthesizing said crosslinked polymer particle, it is necessary to formulate a monomer containing 2 or more radical-polymerizable ethylenic unsaturated groups per molecule. Such a monomer having 2 or more radical-polymerizable ethylenically unsaturated groups is preferably formulated within the range of 0.1 to 70 weight % based on the total monomer. The formulating amount to be selected should be of such an order that the particulate polymer will be provided with a sufficient number of crosslinks to be rendered insoluble in the solvent.

As examples of said monomer containing 2 or more radical-polymerizable ethylenic unsaturated groups per molecule, there can be mentioned ethylene glycol di(meth)acrylate, diethylene glycol di(meth)acrylate, trimethylolpropane di(meth)acrylate, trimethylolpropane tri(meth)acrylate, glycerol di(meth)acrylate, and the like.

The crosslinked polymer particle for use in the present invention is generally formulated in emulsion resins. Since it does not contain a low-molecular emulsifier or protective colloid which will detract from the performance quality of a coating film and, in addition, has been crosslinked by the copolymerization of a monomer containing 2 or more radical-polymerizable ethylenic unsaturated groups per molecule, it contributes to the water resistance, solvent resistance and gloss of the coating film.

The addition amount of said crosslinked polymer particle, based on 100 weight parts of the resin solids of the metallic base coating, is 0.01 to 20 weight parts, preferably 0.1 to 17 weight parts, more preferably 0.2 to 15 weight parts. When the addition amount of said crosslinked polymer particle is in excess of 20 weight parts, the film appearance is sacrificed. When it is below 0.01 weight part, no viscosity control effect can be realized so that an interlayer lmbibing or inversion is liable to take place.

The solid weight ratio of the non-crosslinked polymer particle to the crosslinked polymer particle in the metallic base coating is within the range of 5/1 to 1/5, preferably 2/1 to 1/2. Outside of the above range, the viscosity control effect cannot be obtained.

The luster color pigment to be incorporated in said metallic base coating is morphologically not particularly restricted and may have a color. Preferred, however, is a flake-like pigment having a mean particle diameter (D₅₀) of 2 to 50 μm and a thickness of 0.1 to 5 μm. More preferred is a flake-like pigment with a mean particle diameter of 10 to 35 μm, which is superior in glittering appearance.

The concentration of said luster color pigment in the coating (PWC) is generally not more than 23.0%. If this upper limit is exceeded, the appearance of the coating film will be adversely affected. Preferred range is 0.01% to 20.0%. Still more preferred is the range of 0.01% to 18.0%.

As the luster color pigment mentioned above, there can be mentioned metallic glitters of uncolored or colored metals or alloys and mixtures thereof, interference mica flakes, colored mica powder, white mica powder, graphite, colorless or colored flat pigments, and the like. In view of their good dispersibility and capabilities providing for high-clarity coating films, uncolored or colored metal or alloy glitters and mixtures thereof are preferred. As examples of the material metal, aluminum, aluminum oxide, copper, zinc, iron, nickel, tin, and the like, can be mentioned.

As the colored pigments mentioned above, there can be mentioned organic pigments such as azo chelate pigments, insoluble azo pigments, condensed azo pigments, phthalocyanine pigments, indigo pigments, perinone pigments, perylene pigments, dioxane pigments, quinacridone pigments, isoindolinone pigments, metal complex pigments, etc. and inorganic pigments such as yellow lead, yellow iron oxide, red iron oxide, carbon black, titanium dioxide, and the like. Furthermore, these may be used in combination with extender pigments such as calcium carbonate, barium sulfate, clay, talc, and the like.

The total pigment concentration (PWC), inclusive of the concentrations of said luster color pigment and all other pigments, in the metallic base coating is 0.1 to 50%, preferably 0.5 to 40%, and more preferably 1.0 to 30%. Exceeding the upper limit defined above detracts from the appearance of the coating film.

The film-forming resin to be formulated in said metallic base coating is not particularly restricted but includes acrylic resin, polyester resin, alkyd resin, epoxy resin and urethane resin, among other film-forming resins, and these resins are used in combination with a curing agent such as an amino resin and/or a blocked isocyanate resin. From the standpoint of pigment dispersibility or workability, the use of an acrylic resin and/or a polyester resin in combination with a melamine resin is preferred.

When said metallic base coating is used in a water-based coating system, the film-forming resins specifically described in, inter alia, U.S. Pat. No. 5,151,125 and U.S. Pat. No. 5,183,504 can be used as said film-forming resin. Particularly, the film-forming resin comprising a combination of an acrylic resin having an acrylamido group, a hydroxyl group and an acidic group with a melamine resin as described in U.S. Pat. No. 5,183,504 is desirable in terms of appearance.

For improved coating workability, the above metallic base coating may be supplemented with another viscosity modifier. As examples of such viscosity modifier, there can be mentioned polyamide modifiers such as swollen dispersions of fatty acid amide, amide type fatty acids, long-chain polyaminoamide phosphates, etc., polyethylene series modifiers such as colloidal swollen dispersions of polyethylene oxide, organic bentonite type modifiers such as organic acid-activated smectite clay, montmorillonite, etc., inorganic pigments such as aluminum silicate, barium sulfate, etc., and flat pigments which develop shape-dependent viscosity.

The solid fraction of the metallic base coating of the invention at coating is 15 to 70 weight %, preferably 20 to 50 weight %. When it exceeds the upper limit, the viscosity is too high to insure a good film appearance. When it is below the lower limit, the viscosity is so low that poor-appearance such as lmbibing and irregularities take place. Furthermore, outside of the above range, the stability of the coating is decreased.

The metallic base coating can be generally used with advantage in a solution form. The solution may be any of the organic solvent-based system, water-based system (aqueous solution, aqueous dispersion, emulsion), and non-aqueous dispersion system.

The technology of producing coating compositions for use in the practice of the present invention, inclusive of the following compositions, is not particularly restricted. Thus, any of the techniques well-known in the art, such as the kneader or roll mixing and dispersing of various formulations of pigments and other materials can be utilized.

Clear coating film

In the method of forming a metallic coating film according to the present invention, a clear coating is used for the formation of a clear coating film. The clear coating which can be used includes a clear coating containing a film-forming resin and a curing agent, among other components. The film-forming resin is not particularly restricted but includes acrylic resin, polyester resin, epoxy resin and urethane resin, to mention just a few examples. These resins are used in combination with a curing agent such as an amino resin and/or a blocked isocyanate resin. From the standpoint of clarity or resistance to acid etching, the combination of an acrylic resin and/or a polyester resin with an amino resin or the use of an acrylic resin and/or a polyester resin comprising a carboxylic acid/epoxy curing system is preferred.

The solid fraction of said clear coating is 20 to 60 weight %, preferably 35 to 55 weight %. The solid content at coating is 10 to 50 weight %, preferably 20 to 50 weight %.

Since the clear coating is generally applied after application of a metallic base coating and while the base coating is not cured, it preferably contains a viscosity modifier, such as the one described for said metallic base coating, for the prevention of interlayer lmbibing and inversion or sagging. The addition amount of said viscosity modifier, relative to 100 weight parts of the solid fraction of the clear coating composition, is 0.01 to 10 weight parts, preferably 0.02 to 8 weight parts, more preferably 0.03 to 6 weight parts. When the amount of the viscosity modifier exceeds 10 weight parts, the appearance is adversely affected. If it is less than 0.1 weight part, the viscosity control effect will not be obtained but, rather, troubles such as sagging tend to take place.

The coating system for the clear coating used in the present invention can be any of the organic solvent-based system, the water-based (aqueous solution, aqueous dispersion and emulsion) system, the non-aqueous dispersion system, and the powder coating system. Where necessary, a curing catalyst, a surface conditioner and other components may also be formulated.

Substrate

The method of forming a coating film according to the present invention can be applied to a variety of substrates such as metals, glass, plastics, and foams and, with particular advantage, to metallic products receptive to cation electrodeposition coatings. The metal substrates mentioned above include those made of various metals such as iron, copper, aluminum, tin, zinc, etc. as well as their alloys and castings. Specifically, the bodies and parts of cars, trucks, autobicycles and motor coaches (buses) can be mentioned. It is particularly preferred that these metal substrates have been subjected to a chemical conversion treatment, e.g. phosphating or chromating.

Undercoating film

The undercoating film to be formed on the substrate prior to formation of a metallic coating film according to the present invention is formed using an electrodeposition coating. While the electrodeposition coating may be whichever of the cationic type and the anionic type, the use of a cationic electrodeposition coating composition is conducive to a superior multi-layer coating film in terms of corrosion resistance.

Intermediate coating film

The intermediate coating film which is optionally formed in the metallic coating film-forming method of the present invention is formed using an intermediate coating. The intermediate coating comprises an organic or inorganic color pigment, an extender pigment, a film-forming resin and a curing agent and the other components. The intermediate coat hides the underlying surface, provides for improved surface smoothness after top coating (an improvement in appearance) and imparts the necessary coating film properties (impact resistance, chipping resistance, etc.).

The color pigment for use in said intermediate coating includes the organic and inorganic pigments mentioned for said metallic base coating. In addition, extender pigments and flat pigments such as aluminum flakes and mica flakes can be used in combination.

As a standard formulation, a gray series intermediate coating comprising carbon black and titanium dioxide as principal pigments is employed. It is also possible to use a “set gray” coating designed to match the top coating color in brightness and/or hue or the so-called color intermediate coating comprising a combination of various color pigments.

The film-forming resin for use in said intermediate coating is not particularly restricted but includes acrylic resin, polyester resin, alkyd resin, epoxy resin, urethane resin, and the like, and these resins are used in combination with a curing agent such as an amino resin and/or a blocked isocyanate resin. From the standpoint of pigment dispersability and workability, the combination of an alkyd resin and/or a polyester resin with an amino resin is preferred.

The intermediate coating film may be subjected to further treatment in the uncured state after application to an under-coated substrate but when it is cured, a highly-crosslinked hard coating film can be obtained by curing at a temperature of 100 to 180° C., preferably 120 to 160° C. If the curing temperature exceeds the upper limit, the coating film will be too hard and brittle. Below the lower limit, the degree of cure will be insufficient. The curing time varies with the curing temperature but may be 10 to 30 minutes at 120 to 160 ° C. These conditions are not applicable, of course, when the treatment is carried out in the uncured state.

Procedure for forming a metallic coating film

In the method of forming a metallic coating film according to the present invention, the under-coated, and optionally intermediate-coated, surface of a substrate is coated with a luster color pigment-containing metallic base coating to form a metallic base coating film in the first place.

Generally in coating an automotive body or the like with a metallic base coating, for an improved decorative effect, the coating film is formed in a multi-stage coating system comprising an air electrostatic spray coating, preferably in a 2-stage coating system, or a coating method using an air electrostatic spray coating in combination with a rotary atomizer type electrostatic coating machine commonly called “μ μ (micro-micro)bell,” μ (micro)bell, or “metallic bell”. The method of the present invention can adopt the practice utilizing such coating systems, with advantage.

The metallic base coating for use in the formation of a metallic coating film according to the present invention contains a non-crosslinked polymer particle and a crosslinked polymer particle. The non-crosslinked polymer particle, added by itself, does not provide for structural viscosity but when it is used in combination with the crosslinked polymer particle, a marked structural viscosity is expressed.

This structural viscosity is clearly manifested as the “color inversion” due to delicate intermingling of the metallic base coating film and the clear coating film or the readiness to collapse of coating particles immediately after deposition in spray coating. For example, the rate of shear (shear force) at the time of collision of coating particles on the substrate is said to be 10 (1/sec) and the rate of shear (shear force) immediately after deposition of coating particles on the substrate is said to be 0.1 (1/sec). Therefore, an estimation of the degree of alignment can be made by measuring the viscosities of the coating at the respective rates of shear (shear forces). Thus, the larger the difference between the two viscosity values is, the more ready are the coating particles to collapse, so that the alignment of the luster color pigments contained in the coating particles with the substrate surface is promoted. It should, however, be understood that although the viscosity after coating is preferably low, it is necessary to prevent the luster color pigments once oriented in parallel with the substrate from being disoriented by sagging or flowing.

Actually, the deformation rate as a marker of the readiness of particles to collapse can be calculated by the procedure which comprises trapping coating particles in the spray mist immediately before deposition on the substrate by a silicone oil immersion method, measuring the diameter of the trapped particles, measuring the diameter of coating particles which have just collapsed on deposition in the silicone oil-free area and dividing this diameter by the pre-deposition particle diameter.

That said deformation rate is large means a greater tendency of the coating particle containing the luster color pigment being crushed and deformed from the generally spherical shape to the dome or dish shape on deposition on the substrate, and when the rate of this crushing is high, the luster color pigment particles contained are more greatly oriented in parallel with the substrate surface, so that as the coating film is viewed, a greater flip-flop effect is obtained. When the above deformation rate is small, the luster color pigment particles contained are not oriented in parallel with the substrate so that the flip-flop effect is decreased.

As mentioned above, by imparting structural viscosity to a metallic base coating, it is possible to increase not only the viscosity of the coating but also the deformation rate of coating particles on deposition and thereby increase the flip-flop effect of the metallic coating film.

The coating film thickness of the metallic base coating of the present invention is dependent on the intended use but the range of 5 to 35 μm is useful in many cases. If the upper limit is exceeded, the decreased sharpness and troubles such as coating mottling and drift will be liable to take place. When the thickness is below the lower limit, the undercoating film surface may not be effectively concealed or be locally left exposed.

Thus, the metallic base coating film formed according to the present invention, as such, can be cured by heating at about 100 to 180° C. but, in the method of the present invention, this base coating film and the clear coating film are concurrently cured in one operation.

In a preferred mode of practice, the method of the present invention comprises applying a clear coating on top of an uncured metallic base coating film to construct a clear coating film on a wet-on-wet technique and, then, curing the multi-layer coating film in one operation.

While the metallic coating film obtained by the above procedure appears white and glittering with a high gloss when viewed from the front (right angle against the film surface), it appears somewhat lack-luster when viewed from oblique directions, with a marked difference in gloss dependent on the viewing angle. In other words, there can be obtained a metallic coating film having a prominent flip-flop effect such that the metallic gloss changes considerably according to the viewing angle.

However, when the above metallic base coating is used in a water-based system, application of a clear coating is preferably preceded by heating the metallic base coating film at 60 to 100° C. for 2 to 10 minutes in order to attain a coating film with a good finished appearance.

The clear coating film after formation of said metallic base coating film layer is constructed in order to level off the mottling and random sparkling due to the luster color pigments in the metallic base coating and to protect the base coating film. Preferred coating technique is the method using a rotary atomizing electrostatic coater such as the μ μ-bell or μ-bell mentioned hereinbefore.

The dry thickness of the clear coating film formed by using said clear coating is preferably about 10 to 70 μm, more preferably about 20 to 60 μm, in most cases. When it is over the upper limit, such troubles as popping and sagging may take place in coating. When the dry thickness is below the lower limit, the undercoating surface mottling cannot be covered up.

When the curing temperature for curing the metallic coating film comprising said metallic base coating film and clear coating film is set at 100 to 180° C., preferably 120 to 160° C., a cured coating film of high crosslinking density can be obtained. When the curing temperature is higher than the above upper limit, the coating film becomes too hard and brittle. If it is below the lower limit, the degree of curing will not be sufficient. The curing time, which depends on the curing temperature, may be 10 to 30 minutes at 120 to 160° C.

The film thickness of the multi-layer coating film formed in accordance with the present invention is 30 to 300 μm, preferably 50 to 250 μm, in many instances. If the upper limit is exceeded, the physical properties, such as thermal shock cycle characteristic, of the coating film will not be decreased. If the film thickness is less than the lower limit, the strength of the film itself will be decreased.

When non-crosslinked polymer particles and crosslinked polymer particles are used in the ratio and range as defined in the present invention, a larger structural viscosity is expressed than the system containing crosslinked polymer particles only, with the result that the color inversion due to intermingling of the metallic base coating film and the clear coating film is precluded. Moreover, since the orientation of an aluminum pigment in parallel with the substrate surface is facilitated, a metallic coating film having a prominent flip-flop effect, namely the characteristic that the metallic tone is remarkably varied according to the viewing angle, can be formed with good reproducibility on a commercial scale.

### EXAMPLES

The following examples illustrate the present invention in further detail without defining its scope. It should be noted that, in the following description, all parts are by weight.

### Production Examples

I-1 Production example for a non-crosslinked polymer particle

(a) Production of a dispersion-stabilizing resin

A reaction vessel equipped with a stirrer, temperature control and reflux condenser was charged with 90 parts of butyl acetate. Then, a portion (20 parts) of a solution of the following composition was added.

| | |
|---|---|
| Methyl methacrylate | 38.9 parts |
| Stearyl methacrylate | 38.8 parts |
| 2-Hydroxyethyl acrylate | 22.3 parts |
| Azobisisobutyronitrile | 5.0 parts |

The mixture was heated under stirring, and at 110° C., the balance (85 parts) of the above solution was added dropwise over 3 hours. Then, a solution composed of 0.5 part of azobisisobutyronitrile and 10 parts of butyl acetate was added dropwise over 30 minutes. This reaction mixture was refluxed with stirring for an increased conversion for an additional 2 hours to complete the reaction. As a result, an acrylic resin having a solid content of 50% and a number average molecular weight of 5600 was obtained.

(b) Production of a non-crosslinked polymer particle

A reaction vessel equipped with a stirrer, cooling jacket and temperature control was charged with 35 parts of butyl acetate and 60 parts of the acrylic resin obtained above in (a) Production of a dispersion-stabilizing resin. Then, a solution of the following composition was added dropwise over 3 hours at 100° C.

| | |
|---|---|
| Styrene | 7.0 parts |
| Methacrylic acid | 1.8 part |
| Methyl methacrylate | 12.0 parts |
| Ethyl acrylate | 8.5 parts |
| 2-Hydroxyethyl acrylate | 40.7 parts |
| Azobisisobutyronitrile | 1.4 parts |

Then, a solution composed of 0.1 part of azobisisobutyronitrile and 1 part of butyl acetate was added dropwise over 30 minutes. This reaction mixture was further stirred for 1 hour to give an emulsion with a solid content of 60% and a particle diameter of 0.18 μm. This emulsion was diluted with butyl acetate to give a butyl acetate dispersion of 40 weight % of a non-crosslinked polymer particle with a viscosity of 300 cps (25° C.) and a particle diameter of 0.18 μm.

I-2 Production Example for a non-crosslinked polymer particle

A reaction vessel equipped with a stirrer, cooling jacket and temperature control was charged with 35 parts of butyl acetate and 100 parts of the acrylic resin obtained above in I-1 Production example for a non-crosslinked polymer particle —(a) Production of a dispersion-stabilizing resin. Then, a solution of the following composition was added dropwise over 3 hours at 100° C.

| | |
|---|---|
| Methacrylic acid | 1.3 parts |
| Methyl methacrylate | 18.4 parts |
| Ethyl acrylate | 18.2 parts |
| 2-Hydroxyethyl methacrylate | 12.2 parts |
| Azobisisobutyronitrile | 1.4 parts |

Then, a solution composed of 0.1 part of azobisisobutyronitrile and 1 part of butyl acetate was added dropwise over 30 minutes. This reaction mixture was further stirred for 1 hour to give an emulsion having a solid content of 60%, a viscosity of 80 cps (25° C.), and a particle diameter of 0.14 μm.

II Production Example for a crosslinked polymer particle

(a) Production of a zwitterion group-containing polyester resin

A 2 L-flask equipped with a stirrer, nitrogen inlet pipe, temperature control, cooling condenser and decanter was charged with 134 parts of bishydroxyethyltaurine, 130 parts of neopentyl glycol, 236 parts of azelaic acid, 186 parts of phthalic anhydride and 27 parts of xylene and heated. The byproduct water was azeotropically distilled off with xylene. The temperature was brought to 190° C. in about 2 hours after the start of refluxing and the stirring and dehydration were continued until the carboxylic acid equivalent acid value had reached 145, followed by cooling to 140° C. Then, with the temperature held at 140° C., 314 parts of Cardura E-10 (Shell; diglycidyl versatate) was added dropwise over 30 minutes. The mixture was further stirred for 2 hours to complete the reaction. The resulting polyester resin had an acid value of 59, a hydroxyl value of 90, and a number average molecular weight of 1054.

(b) Production of a crosslinked polymer particle

A 1 L-reaction vessel equipped with a stirrer, cooling jacket and temperature control was charged with 232 parts of deionized water, 10 parts of the polyester resin obtained above in II (a) Production of a zwitterion group-containing polyester resin, and 0.75 part of dimethylethanolamine, and the temperature was maintained at 80° C. under stirring. To the resulting solution was added a solution of 4.5 parts of azobiscyanovaleric acid in a mixture of 45 parts of deionized water and 4.3 parts of dimethylethanolamine. Then, a mixed solution composed of 130 parts of methyl methacrylate, 40 parts of styrene and 140 parts of ethylene glycol dimethacrylate was added dropwise over 60 minutes. After completion of dropwise addition, a solution of 1.5 parts of azobiscyanovaleric acid in a mixture of 15 parts of deionized water and 1.4 parts of dimethylethanolamine was further added and the mixture was stirred at 80° C. for 60 minutes. The resulting emulsion had a solid content of 45%, a pH value of 7.2, a viscosity of 92 cps (25° C.), and a particle diameter of 0.1 μm. The continuous phase of this emulsion was azeotropically replaced with xylol to give a xylol dispersion containing 20 weight % of a crosslinked polymer particle having a particle diameter of 0.07 μm.

III-1 Production of an acrylic resin

A reaction vessel equipped with a stirrer, temperature control and reflux condenser was charged with 50 parts of xylene and 25 parts of n-butanol. Then, a portion (20 parts) of a solution of the following composition was added.

| | |
|---|---|
| Styrene | 5.0 parts |
| Methacrylic acid | 1.5 parts |
| Methyl methacrylate | 20.0 parts |
| Ethyl acrylate | 45.0 parts |
| 2-Hydroxyethyl acrylate | 6.6 parts |
| Butoxymethylacrylamide | 5.0 parts |
| Praccel FM-2 | 17.6 parts |
| (Daicel Chemical; OH-containing monomer) | |
| Azobisisobutyronitrile | 7.0 parts |

The mixture was heated with constant stirring. Then, under reflux, the balance (87.7 parts) of the above solution was added dropwise over 3 hours. Then, a solution composed of 0.2 part of azobisisobutyronitrile and 8 parts of xylol was added dropwise over 30 minutes. This reaction mixture was further refluxed for an increased conversion for another hour to complete the reaction. As a result, an acrylic resin varnish with a solid content of 55% and a number average molecular weight of 3800 was obtained.

III-2 Production of an acrylic resin

The same apparatus as the one used in Production Example III-1 was charged with 55 parts of xylene and 25 parts of n-butanol. Then, a portion (20parts) of the following solution was added and the mixture was heated with stirring.

| | |
|---|---|
| Styrene | 5.0 parts |
| Methacrylic acid | 3.6 parts |
| Methyl methacrylate | 15.0 parts |
| Ethyl acrylate | 37.4 parts |
| 2-Hydroxyethyl acrylate | 9.0 parts |
| Butoxymethylacrylamide | 10.0 parts |
| Placcel FM-2 | 20.0 parts |
| (Daicel Chemical; OH-containing monomer) | |
| Azobisisobutyronitrile | 7.0 parts |

Then, under reflux, the balance (87.0parts) of the above solution was added dropwise over 3 hours. Thereafter, a solution composed of 0.2 part of azobisisobutyronitrile and 8 parts of xylene was added dropwise over 30 minutes. This reaction mixture was further refluxed and stirred for another hour to complete the reaction. The acrylic resin varnish thus obtained had a solid content of 55% and a number average molecular weight of 3700.

III-3 Production of an acrylic resin

The same apparatus as the one used in Production Example III-1 was charged with 82 parts of xylene and a portion (20parts) of a solution of the following composition was added.

| | |
|---|---|
| Methacrylic acid | 4.5 parts |
| Ethyl acrylate | 26.0 parts |
| Placcel FM-1 | 64.5 parts |
| (Daicel Chemical; OH-containing monomer) | |
| MSD-100 | 5.0 parts |
| (Mitsui Toatu Chemical; methylstyrene dimer) | |
| Azobisisobutyronitrile | 13.0 parts |

The mixture was heated with stirring. Then, under reflux, the balance (93.0 parts) of the above solution was added dropwise over 3 hours. Thereafter, a solution composed of 1.0 part of azobisisobutyronitrile and 12 parts of xylene was added dropwise over 30 minutes. This reaction mixture was further refluxed and stirred for another hour, at the end of which time 63 parts of the solvent was distilled off under reduced pressure to complete the reaction. The acrylic resin varnish thus obtained had a solid content of 75% and a number average molecular weight of 2000.

IV Production of a metallic base coating

In a stainless steel vessel, 73 parts of the varnish obtained in Production Example III-1, 27 parts of the varnish obtained in Production Example III-3, 50 parts of U-Van 20N60 (Mitsui Toatsu; melamine resin, 60% solids), 50 parts of the crosslinked polymer particle obtained in Production Example II, 25 parts of the non-crosslinked polymer particle obtained in Production Example I-1, and 15 parts of Alumipaste 91-0562 (Toyo Aluminum Co.; aluminum pigment) were weighed and stirred with a bench-top stirring machine to prepare a metallic base coating.

### Example 1

Formation of a metallic coating film

On a 0.8 mm-thick dull steel panel which had undergone a chemical conversion treatment with zinc phosphate, a cationic electrodeposition coating V-50 (Nippon Paint) was deposited in a cured film thickness of about 20 μm and heated for curing at 160° C. for 30 minutes . Then, a gray intermediate coating “Orga P-2 Primer” (Nippon Paint) was air spray-coated in a cured film thickness of about 25 μm, allowed to sit at room temperature for 3 minutes, and cured at 140° C. for 30 minutes to give a substrate.

The metallic base coating IV prepared above was diluted with a thinner composed of 50 parts of Solvesso 150 (Exon Oil, a hydrocarbon solvent), 25 parts of ethyl acetate and 25 parts of toluene to a No. 4 Ford Cup viscosity of 12.5 seconds/20° C.

The above substrate, solvent-degreased, was erected in a vertical position and coated with the above metallic base coating in a dry film thickness of 15 μm in 2 stages at an 1.5-minute interval using “Metabell” (Randsburg; a rotary atomizing electrostatic coating machine). The coated substrate was allowed to stand at room temperature for 4 minutes to prepare a metallic base coating film.

Then, a clear coating “MacFlow O-380” (Nippon Paint) diluted to a No. 4 Ford Cup viscosity of 25 sec/20° C. in advance was applied once on a wet-on-wet mode in a dry thickness of 35 μm. Then, the coated substrate was allowed to stand in a vertical position at room temperature for 7 minutes and, then, cured for 30 minutes in the same position by means of a dryer set at 140° C. In this manner, a metallic coating film was obtained by the 2-coat/1-bake method.

Formation of a control metallic base single-layer coating film

On a gray intermediate-coated steel panel similar to that used in the above formation of a metallic coating film, a metallic base coating film was constructed by using only the metallic base coating IV prepared above in the same manner in 2 successive coatings in a dry film thickness of 15 μm. The coated substrate was allowed to stand in a vertical position at room temperature for 7 minutes and, then, cured in the same position by means of a dryer set at 140° C. for 30 minutes to give a metallic base single-layer coating film.

The metallic coating films were evaluated by the following methods.

<Orientation of aluminum>

The metallic coating film obtained by the 2-coat/1-bake method and the metallic base single-layer coating film were visually evaluated for flip-flop effect and scored on the following scale.

Rating scale

5: Definitely superior

4: Slightly superior

3: Equivalent to standard

2: Slightly inferior

1: Definitely inferior

<Color inversion>

Using the corresponding metallic base single-layer coating film as a standard, the color difference between it and the metallic coating film obtained by the 2-coat/1-bake method was measured and scored on the following scale.

Rating scale

5: Color difference≦0.5

4: Color difference 1.0 to 0.6

3: Color difference 1.5 to 1.1

2: Color difference 2.0 to 1.6

1: Color difference ≧2.1

<Gloss>

The gloss of the metallic coating film obtained by the 2-coat/1-bake method was measured with The “Gloss Tester GOT-01” manufactured by Tokai Rika Denki Seisakusho, Ltd.

<Coating viscosity>

The metallic base coating obtained in Production Example IV was adjusted to the solid fraction (70%) immediately after deposition in advance and using the rheometer MR-300 (Rheology Co., Soliquid Meter), the viscosity at the rate of shear (shear force) of 10 (1/sec) was measured. The result was 150 poises. The viscosity at the rate of shear (shear force) of 0.1 (1/sec) was found to be 620 poises.

<Particle diameter of spray coating mist>

The particles immediately before deposition of the coating particles were trapped by the silicone oil immersion method and the diameter was measured. At the same time, the diameter of the particles deposited on the silicone oil-free area and crushed was measured and divided by the pre-deposition particle diameter to calculate the deformation rate as a marker of the readiness to collapse.

The particle diameter of the metallic base coating obtained in Production Example IV, in which both a crosslinked polymer particle and a non-crosslinked polymer particle were formulated, was 12.6 μm and the deformation rate was found to be 1.89. The results of the above evaluations are shown in Table 1.

### Examples 2 and 3

Using each of the metallic base coatings prepared according to the formulations shown in Table 1 but otherwise in the same manner as the metallic base coating of Example 1, a metallic coating film and a metallic base single-layer coating film were constructed and evaluated in the same manner as in Example 1.

### Examples 4 to 10

Using the formulations shown in Table 1, metallic base coatings were prepared in the same manner as in Example 1 except that color pigments, namely Cyanine Blue 5206 (Dainichi Seika, blue pigment) and Cinncassia Magenta BRT-343D (Ciba-Geigy, red pigment), were dispersed and the aluminum pigment used in Example 1 was replaced with Alpaste MH-8801 (Asahi Kasei; aluminum pigment) or Alpaste MH-9901 (Asahi Kasei; aluminum pigment). Then, a metallic coating film and a metallic base single-layer coating film were respectively prepared and evaluated in the same manner as in Example 1.

### Comparative Examples 1 to 4

Metallic base coatings were prepared without using the crosslinked polymer particle or non-crosslinked polymer used in Examples 1 to 10. Using each of these coatings, a metallic coating film and a metallic base single-layer coating film were prepared and evaluated in the same manner as described hereinbefore.

Furthermore, the viscosity values at the rate of shear (shear force) of 10 (1/sec) in spray coating were measured for the metallic base coatings used in the above Comparative Examples 1 and 2 in the same manner as in Example 1. As a result, the viscosity of the crosslinked polymer particle-containing metallic base coating of Comparative Example 1 was 250 poises and that of the non-crosslinked polymer particle-containing metallic base coating of Comparative Example 2 was 120 poises. At the rate of shear (shear force) of 0.1 (1/sec) in spray coating, the viscosity of the crosslinked polymer particle-containing metallic base coating of Comparative Example 1 was 650 poises and that of the non-crosslinked polymer particle-containing metallic base coating of Comparative Example 2was 120 poises.

In addition, by the silicone oil immersion method, the spray mist particles of the metallic base coating used in the above Comparative Example 1 were trapped as in Example 1 and the particle diameter was measured. At the same time, the diameter of the particles deposited in the silicone oil-free area and crushed was measured and divided by the pre-deposition diameter measured as above to find the deformation rate as a marker of the readiness to collapse. It was found that the particle diameter of the crosslinked polymer particle-containing metallic base coating of Comparative Example 1 was 13.4 μm and the deformation rate of the coating particles was 1.46. In the case of Comparative Example 2, the coating particle diameter was 12.5 μm and the deformation rate was 1.90.

The results of evaluations in the foregoing Examples and Comparative Examples are summarized in Table 1.

TABLE 1

| | | Example | | | | | | | | | | Compar. Ex. | | | |
|---|---|---|---|---|---|---|---|---|---|---|---|---|---|---|---|
| | | 1 | 2 | 3 | 4 | 5 | 6 | 7 | 8 | 9 | 10 | 1 | 2 | 3 | 4 |
| Formula- | Varnish of Production Ex. III-1 | 73.0 | — | — | — | — | — | — | — | — | — | 91.0 | 73.0 | | |
| tion | Varnish of Production Ex. III-2 | — | 73.0 | 73.0 | 87.5 | 82.1 | 73.0 | 54.8 | 73.0 | 73.0 | 73.0 | | | 91.0 | 73.0 |
| | Varnish of Production Ex. III-3 | 27.0 | 27.0 | 27.0 | 27.0 | 27.0 | 27.0 | 27.0 | 27.0 | 27.0 | 27.0 | 27.0 | 27.0 | 27.0 | 27.0 |
| | crosslinked polymer particle of | 50.0 | 50.0 | 50.0 | 50.0 | 50.0 | 50.0 | 50.0 | 10.0 | 25.0 | 100.0 | 50.0 | — | 50.0 | — |
| | Production Ex. II | | | | | | | | | | | | | | |
| | Non-crosslinked polymer | 25.0 | 25.0 | — | 5.0 | 12.5 | 25.0 | 50.0 | 25.0 | 25.0 | 25.0 | — | 25.0 | — | — |
| | particle of Production Ex. I-1 | | | | | | | | | | | | | | |
| | Non-crosslinked polymer | — | — | 16.7 | — | — | — | — | — | — | — | — | — | — | 16.7 |
| | particle of Production Ex. I-2 | | | | | | | | | | | | | | |
| | U-Van 20N60 | 50.0 | 50.0 | 50.0 | 50.0 | 50.0 | 50.0 | 50.0 | 50.0 | 50.0 | 50.0 | 50.0 | 50.0 | 50.0 | 50.0 |
| | Alpaste 91-0562 | 15.0 | 15.0 | 15.0 | — | — | — | — | — | — | — | 15.0 | 15.0 | | |
| | Alpaste MH-8801 | — | — | — | 7.9 | 7.9 | 7.9 | 7.9 | 7.9 | 7.9 | 7.9 | — | — | 7.9 | 7.9 |
| | Alpaste MH-9901 | — | — | — | 3.4 | 3.4 | 3.4 | 3.4 | 3.4 | 3.4 | 3.4 | — | — | 3.4 | 3.4 |
| | Cyanine Blue 5206 | — | — | — | 1.5 | 1.5 | 1.5 | 1.5 | 1.5 | 1.5 | 1.5 | — | — | 1.5 | 1.5 |
| | Cinncassia Magenta BRT-343D | — | — | — | 0.4 | 0.4 | 0.4 | 0.4 | 0.4 | 0.4 | 0.4 | — | — | 0.4 | 0.4 |
| | Amount of crosslinked | 10 | 10 | 10 | 10 | 10 | 10 | 10 | 2 | 5 | 20 | 10 | — | 10 | — |
| | polymer particle II | | | | | | | | | | | | | | |
| | Kind of non-crosslinked | I-1 | I-1 | I-2 | I-1 | I-1 | I-1 | I-1 | I-1 | I-1 | I-1 | — | I-1 | — | I-2 |
| | polymer particle | | | | | | | | | | | | | | |
| | Amount of non-crosslinked | 10 | 10 | 10 | 2 | 5 | 10 | 20 | 10 | 10 | 10 | — | 10 | — | 10 |
| | polymer particle | | | | | | | | | | | | | | |
| Evaluation | Orientation of Al in single | 5 | 4 | 4 | 4 | 5 | 5 | 5 | 3 | 5 | 5 | 4 | 2 | 4 | 2 |
| | base coat | | | | | | | | | | | | | | |
| | Orientation of Al in 2C/1B | 4 | 3 | 3 | 3 | 5 | 5 | 5 | 2 | 5 | 4 | 1 | 1 | 1 | 1 |
| | coat | | | | | | | | | | | | | | |
| | Color drift-back | 4 | 4 | 4 | 2 | 4 | 5 | 5 | 4 | 4 | 4 | 1 | 2 | 1 | 2 |
| | Gloss | 96.2 | 92.1 | 92.4 | 92 | 95 | 96.2 | 95.5 | 93.5 | 96 | 95.1 | 91.1 | 90.5 | 89.1 | 90.2 |
| | Viscosity at a shear rate of 10 | 150 | — | — | — | — | — | — | — | — | — | 250 | 120 | — | — |
| | (l/sec)(poise) | | | | | | | | | | | | | | |
| | Viscosity at a shear rate of | 620 | — | — | — | — | — | — | — | — | — | 650 | 120 | — | — |
| | 0.1 (l/sec)(poise) | | | | | | | | | | | | | | |
| | Deformation rate of spray | 1.89 | — | — | — | — | — | — | — | — | — | 1.46 | 1.9 | — | — |
| | coating | | | | | | | | | | | | | | |

It is apparent from Table 1 that the metallic coating films according to Examples 1 to 10 of the invention, wherein both a non-crosslinked polymer particle and a crosslinked polymer particle are incorporated, feature improvements in the alignment of an aluminum pigment in the metallic base coating film and in the color inversion characteristic and are very satisfactory in the gloss of the metallic coating film obtained by the 2-coat/1-bake method.

Thus, as the delicate inversion of aluminum flakes can be inhibited in accordance with the present invention, the uneven feeling of the coating film is eliminated and a glossy coating film having a high flip-flop effect can be obtained. In contrast, the control coating systems which did not contain non-crosslinked polymer particles were poor in the orientation of aluminum, color inversion, and gloss.

The difference between the viscosity at the rate of shear (shear force) of 10 (1/sec) and the viscosity at the rate of shear (shear force) of 0.1 (1/sec) indicates that the structural viscosity is largest for the coating system in which both crosslinked polymer and non-crosslinked polymer particles are incorporated. This difference is clearly reflected in the diameter of the spray mist particles and the ease of collapsing of the coating particle. This deformation rate indicates that the coating system containing both crosslinked polymer and non-crosslinked polymer particles is superior in the particle size reduction and in the ease of collapsing, suggesting that an aluminum pigment is more ready to become oriented in parallel with the substrate surface.

1. A method of forming a metallic coating film comprising forming a metallic base coating film and a clear top coating film on a substrate provided with an undercoating film and optionally an intermediate coating film in advance,
wherein the metallic base coating for forming said metallic base coating film contains a non-crosslinked polymer particle having a mean particle diameter (D₅₀) of 0.05 to 10 μm and a crosslinked polymer particle having a mean particle diameter (D₅₀) of 0.01 to 1 μm in a ratio of the former/latter =5/1 to 1/5 on a solid fraction weight basis.

2. A metallic base coating for use in the method according to claim 1.

3. A metallic coating film obtainable by the method according to claim 1.
